(19) United States
(12) Patent Application Publication
(10) Pub. No.: US 2013/0125705 A1
(43) Pub. Date: May 23, 2013

(54) METAL DROSS CONFINEMENT UNIT AND ASSOCIATED METHOD

(71) Applicants: Guy Belley, Saguenay (CA); Charles Dumont, Saguenay (CA); Robin Boulianne, Saguenay (CA)

(72) Inventors: Guy Belley, Saguenay (CA); Charles Dumont, Saguenay (CA); Robin Boulianne, Saguenay (CA)

(73) Assignee: STAS INC., Saguenay, QC (CA)

(21) Appl. No.: 13/810,404

(22) PCT Filed: Jul. 15, 2011
(86) PCT No.: PCT/CA11/00812

§ 371 Date: Jan. 15, 2013

Related U.S. Application Data
(60) Provisional application No. 61/365,074, filed on Jul. 16, 2010.

(51) Int. Cl. B01J 3/03

(52) U.S. Cl. CPC B01J 3/03
USPC 75/330; 220/200; 220/378

(57) ABSTRACT

The present document describes a method and confinement unit for stopping a chemical reaction involving hot metal dross and a gas in the surrounding environment. The method comprises transferring the hot metal dross in a dross pan and placing the dross pan with the metal dross therein in the gastight chamber. Then, the dross pan is sealed with the hot metal dross therein into a gastight chamber of a fixed interior volume. The chemical reaction occurring inside the gastight chamber depletes a limited amount of gas present inside the gastight chamber, thereby stopping once the gas is completely depleted. The gastight chamber is shaped and sealed to withstand a pressure differential created by the depleting of the gas in the fixed interior volume, until the hot dross is cooled and the chemical reaction has stopped.

### CROSS-REFERENCE TO RELATED APPLICATIONS

This application claims priority from United States provisional patent application no. 61/365,074 dated Jul. 16, 2010.

### BACKGROUND

(a) Field

The subject matter disclosed generally relates to the production of metal. More particularly, the disclosure concerns the cooling and confining of metal dross. It also can apply to cooling of residues from metal dross treatment

(b) Related Prior Art

Furnace skim or dross is a normal and sometimes undesirable by-product of operations involving molten metal such aluminum. However, it may represent an economical opportunity when properly managed. The dross recovered from the surface of molten metal contains free metal, usually in concentrations sufficiently large to be worth recovering. At this stage the dross is very hot. It is advantageous to treat such dross so as to cool it in an acceptable short time down to a temperature where it no longer undergoes a self-propagating exothermic reaction with the oxygen present in the air (i.e., oxidation) and can be safely and easily manipulated.

A method (and associated apparatus) disclosed in U.S. Pat. No. 4,842,255 consists in loading the dross in a specially adapted pan and placing it inside a cooler unit called an “Inert Gas Dross Cooler”. The cooler unit is then closed and a regulated flow of an inert gas, such as argon, is injected in the closed cooler unit to neutralize/exclude the oxygen require for oxidation to occur. A disadvantage of such a method is that, in some parts of the world where metal is produced, inert gas it too expensive or simply not available.

Another known method is disclosed in U.S. Pat. No. 4,097,027. It describes a pan cooling system comprising a container for holding the dross positioned on a base surrounded by a moat containing water; and an open-bottomed bell to be lowered over the container until the skirt of the bell is immersed in the water in the moat. As the oxygen in the space between container and bell is consumed, by reaction with residual metal in the dross, the pressure falls and water rises round the container and acts as a heat sink for cooling of the dross. Because of the rising water, the volume under the bell is variable (i.e., not fixed). One disadvantage of the system is that, as a result of the use of a water seal, water vapor is present in the atmosphere within the bell and constitutes a potential undesirable effect. Water vapor is reduced by, for example, metallic aluminum to hydrogen which can explode when the bell is lifted and air allowed back into contact with the dross.

### SUMMARY

There is described herein an apparatus to confine residues generated by molten metal for use from the generation site up to the treatment site. The apparatus may have two applications depending on the time requirement from the generation site to treatment site. Accordingly, it can be used as a cooling unit or holding unit. Hot residues/dross loaded in a dross pan are placed directly into a chamber of the apparatus. A cover is put in place to close the chamber and to ensure no external gases can reach the residues thus preventing further chemical reactions and eliminating any dust emission. The apparatus can be moved easily since basically, there is no addition of media/gases. On the other hand, it can be static or stackable to limit the footprint when used in a warehouse type application.

The apparatus therefore avoids the use of water, which can be quite dangerous, reduces the amount of parts, increases the ease of fabrication, reduce manufacturing costs, avoids using complex seals which would be exposed to very high temperature, avoids handling dusty materials, increases metal recovery from dross/residues, and provides simpler operation, the possibility of mobility and easier tracking. Furthermore, the apparatus is easier to use, has a longer operating life, lower maintenance requirements thereby resulting in lower operating costs. Finally, and in its basic configuration, the concept described herein is utility-free; that is, there is no need for electric power or any outside source of gas, such as inert gases.

According to an embodiment, there is provided a metal dross confinement unit for stopping a chemical reaction involving metal dross and a gas in a surrounding environment. The metal dross confinement unit comprises: a confinement chamber having a fixed volume, the confinement chamber comprising an opening adapted to receive therethrough a dross pan containing the metal dross; and a cover for closing the opening and sealing the confinement chamber in a gastight fashion to thereby ensure the fixed volume inside the confinement chamber. The chemical reaction occurring inside the confinement chamber depletes a limited amount of gas present inside the confinement chamber, thereby stopping once the gas is completely depleted.

According to an aspect, the confinement unit further comprises a support platform within the confinement chamber, the support platform for receiving the dross pan.

According to an aspect, the confinement chamber comprises a substantially cylindrical portion having a cylinder axis.

According to an aspect, the confinement unit further comprises a support structure on which is laid the substantially cylindrical portion with the cylinder axis in a substantially horizontal direction.

According to an aspect, the cover comprises at least one of a dome portion and a hemispherical portion.

According to an aspect, one of the cover and the confinement chamber comprises a cavity adapted to receive an edge portion of the other one of the cover and the confinement chamber thereby forming a seal.

According to an aspect, the confinement unit further comprises a gasket within the cavity thereby enhancing a sealing capacity of the seal.

According to an aspect, the confinement unit further comprises a service port for connecting a pump thereto and pumping gas out of the metal dross confinement unit.

According to an aspect, the confinement unit further comprises a vacuum relief valve for, upon opening, allowing equalization of the pressure between the inside and the outside of the metal dross confinement unit.

According to an aspect, the confinement chamber is shaped and sealed to withstand a pressure differential created by the depleting of the gas in the fixed volume, until the metal dross is cooled and the chemical reaction has stopped.

According to another embodiment, there is provided a method for stopping a chemical reaction involving metal dross and a gas in a surrounding environment. The method comprises sealing a dross pan with the metal dross therein into a gastight chamber of a fixed interior volume, the chemical reaction occurring inside the gastight chamber depleting a limited amount of gas present inside the gastight chamber, thereby stopping once the gas is completely depleted.

According to an aspect, the method further comprises keeping the dross pan in the gastight chamber for at least one of cooling and holding the metal dross in the dross pan for a given period or until a temperature inside the gastight chamber reaches a given value.

According to an aspect, the given period is between 6 and 16 hours.

According to an aspect, the given value is 450° C.

According to an aspect, the method further comprises opening a vacuum relief valve after the given period or after the temperature inside the gastight chamber reaches the given value.

According to an aspect, the method further comprises comprising pumping gas out of the gastight chamber.

According to an aspect, the sealing comprises closing a cover of the gastight chamber.

According to an aspect, the method further comprises comprising transferring the metal dross in the dross pan.

According to an aspect, the method further comprises placing the dross pan with the metal dross therein in the gastight chamber.

According to another embodiment, there is provided a use of a gastight chamber for stopping a chemical reaction involving metal dross and a gas in a surrounding environment.

According to an aspect, the gastight chamber is a vacuum chamber.

The gastight chamber for the use is according to any of the combinations of the limitations for the gastight chamber/confinement chamber/confinement unit described herein. The use itself can be modified according to any combination of the method steps described herein.

The presently described apparatus and method is applicable to various types of metals including, but not limited to, aluminum, zinc, magnesium (or other light metals), or steel.

The chemical reaction described herein applies to gases such as oxygen (i.e., oxidation), nitrogen (i.e., nitrogenization), carbon monoxide and carbon dioxide (i.e., carburization).

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is an isometric view illustrating the metal dross confinement unit according to an embodiment of the present disclosure;

FIG. 2 is a top plan view illustrating the metal dross confinement unit of FIG. 1;

FIG. 3 is a side elevation view illustrating the metal dross confinement unit of FIG. 1;

FIG. 4 is a end elevation view showing a profile of the metal dross confinement unit of FIG. 1; and

FIG. 5 is a block diagram of a method for stopping a chemical reaction of hot metal dross with a gas in the surrounding air according to an embodiment of the present disclosure.

It will be noted that throughout the appended drawings, like features are identified by like reference numerals.

### DETAILED DESCRIPTION OF THE PREFERRED EMBODIMENTS

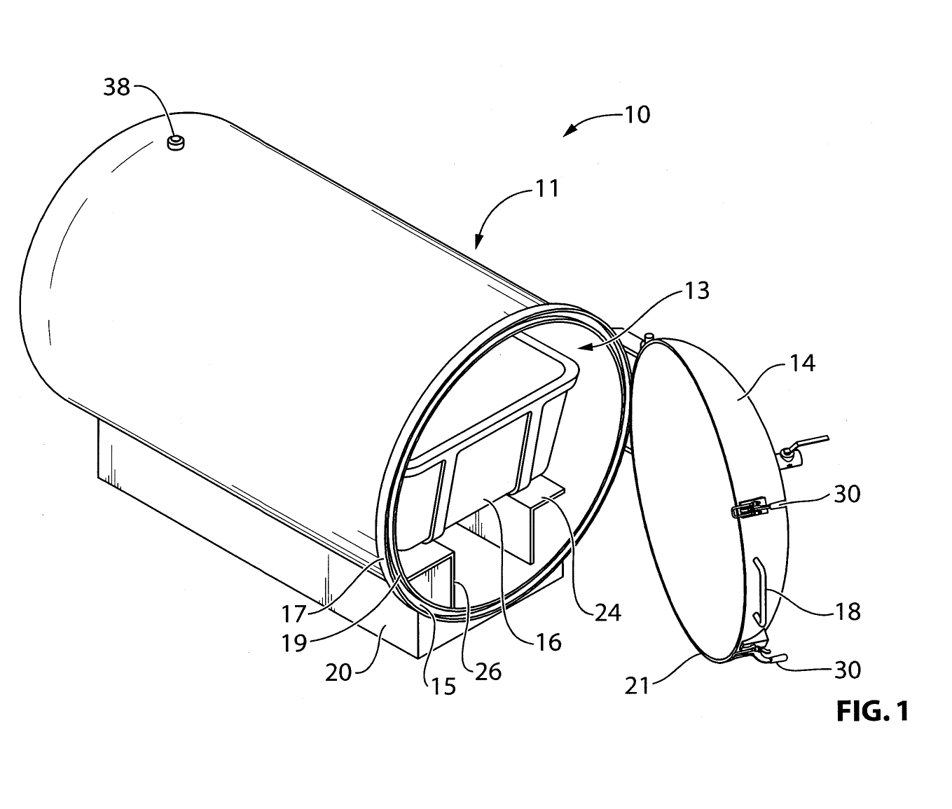

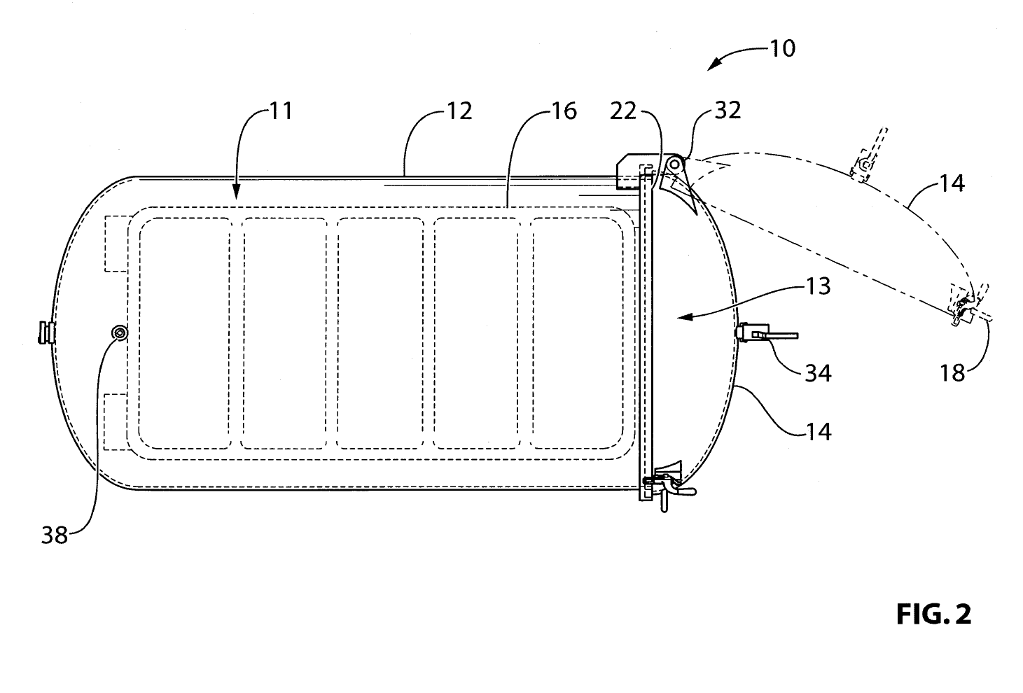

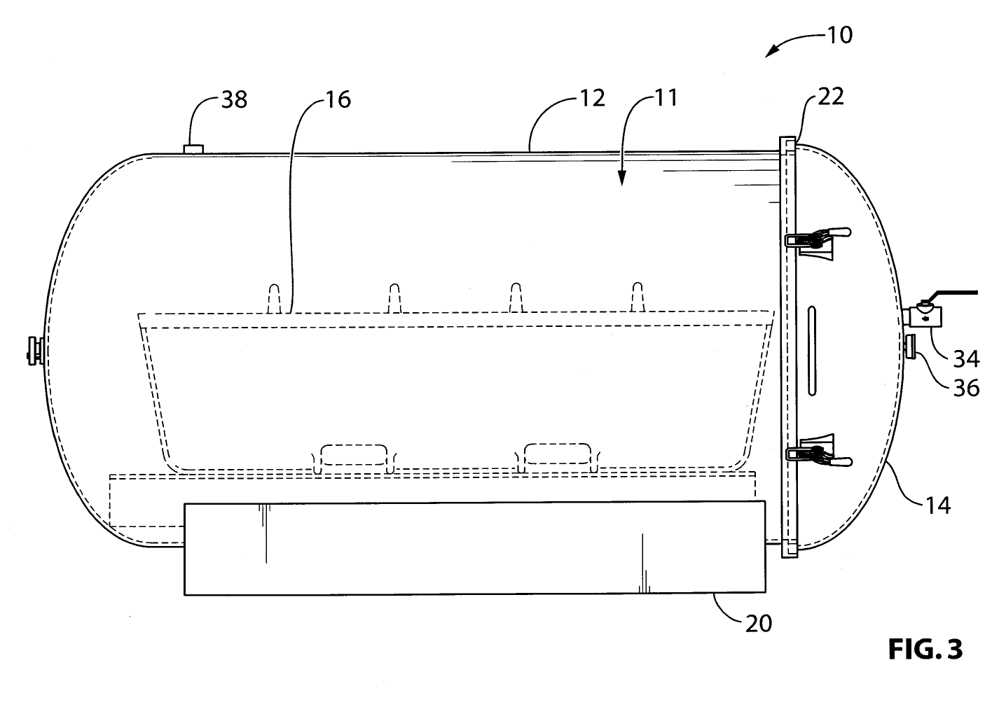

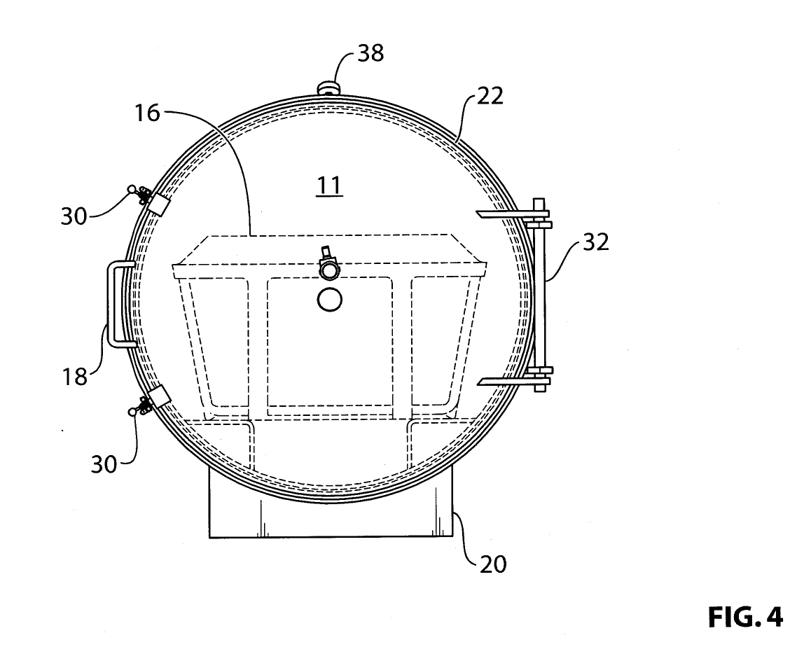

Referring now to the drawings, and more particularly to FIGS. 1, 2, 3 and 4, an embodiment of a metal dross confinement unit 10 for stopping a chemical reaction of hot metal dross with a gas in the surrounding air is described.

The metal dross confinement unit 10 comprising a confinement chamber 11 and a cover 14. The confinement chamber 11 is limited by wall 12.

The confinement chamber 11 has a fixed volume. The confinement chamber 11 comprises an opening 13 adapted to receive therethrough a dross pan 16 for containing the hot metal dross. The dross pan 16 is normally made of but not limited to cast iron.

The cover 14 is for closing the opening 13 and for sealing the confinement chamber 11 in a gastight fashion to thereby ensure a fixed volume inside the confinement chamber 11. The cover 14 may include a hinge 32 and a handle 18 to facilitate handling of the cover 14. The cover 14 forms with the confinement chamber 11 a seal 22.

The cover 14 further includes a guiding and clamping means 30 which ensures gastight closing of the confinement chamber 11 upon closing the opening 13 with the cover 14. The seal 22 is made so that it is not exposed to mechanical or thermal damage. The confinement chamber 11 comprises a cavity 15 formed by lips 17 and 19 that interacts with the edge 21 of the cover 14 to provide the required seal 22. Alternatively, the cover comprises the cavity formed by the lips (not shown) or both the cover 14 and the confinement chamber 11 comprise lips (not shown) which interact to provide the required seal 22.

According to an embodiment, the cover comprises a dome portion or a hemispherical portion.

A gasket (not shown) may also be provided within the cavity 15 for enhancing the sealing capacity of the seal 22. According to an embodiment, the gasket is made of a material which has high temperature resistance and which exhibits shape memory characteristics (e.g., a pseudoelastic material).

The chemical reaction occurring inside the confinement chamber 11 depletes a limited amount of gas present inside the confinement chamber 11 thereby stopping once the gas is completely depleted. The confinement chamber 11 is shaped and sealed to withstand a pressure differential created by the depleting of the gas in the fixed volume, until the hot dross is cooled and the chemical reaction has stopped. The pressure differential will normally be as closed as possible to a vacuum.

The confinement chamber 11 comprises a substantially cylindrical portion having a cylinder axis. The metal dross confinement unit 10 may further comprise a support structure 20 on which is horizontally laid the confinement chamber 11 with the cylinder axis being substantially horizontal.

The support structure 20 may be equipped with transportation utilities such as forklift pockets (not shown) or mobility devices (not shown) to facilitate transport of the metal dross confinement unit 10. The support structure 20 may also be adapted for stacking metal dross confinement units 10.

The metal dross confinement unit 10 may also further comprise a support platform having, according to an embodiment, right and left portions 24 and 26 on which the dross pan 16 is laid. In an embodiment, the right and left portions 24 and 26 are L-shaped and are mirror images of each other. The dross pan 16 is normally equipped with inserts for the forks of a forklift to facilitate transport of the dross pan 16.

The metal dross confinement unit 10 also comprises a vacuum relief valve 34 which is used to allow for equalization of the pressure between the inside and the outside of the metal dross confinement unit 10 once the chemical reaction has stopped.

Service ports (not shown) may be used to pump gas out of the confinement chamber 11 to create a vacuum or may also be used to flush the metal dross confinement unit 10 with a gas prior to its opening.

Finally, the metal dross confinement unit 10 may comprise a pressure gage 36, a surpressure valve 38 (aka a pressure relief valve or pressure control valve).

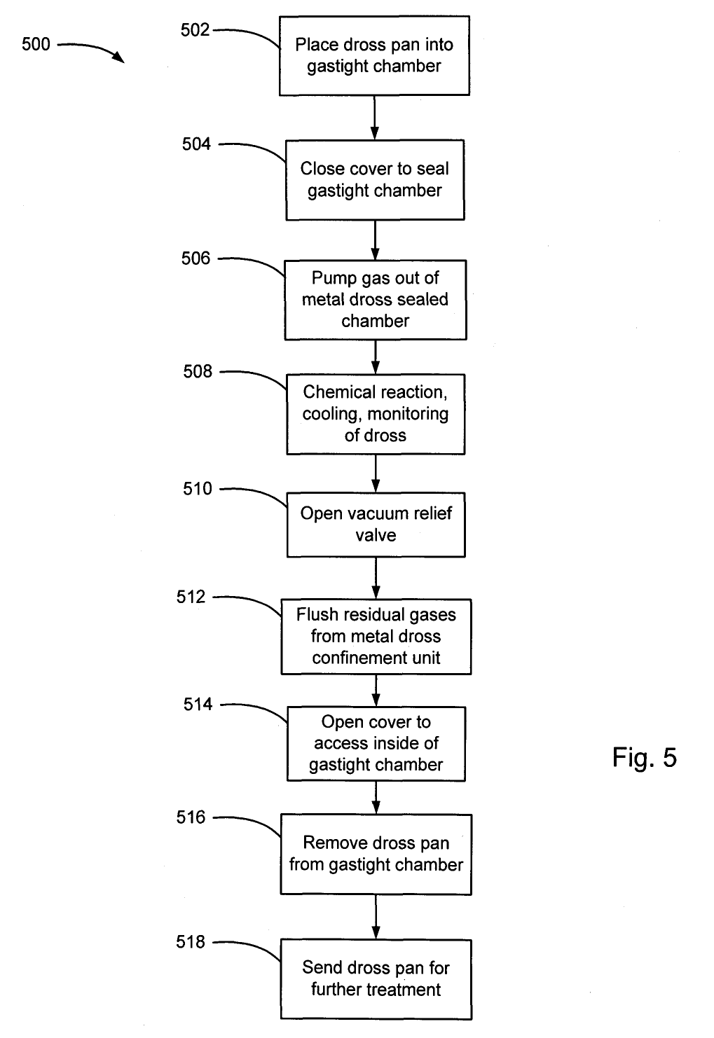

Now turning to FIG. 5, there is shown a method 500 for stopping a chemical reaction involving hot metal dross and a gas in the surrounding air according to an embodiment of the present disclosure. The method 500 also illustrates the use and operation of the metal dross confinement unit 10.

The method 500 comprises, in step 502, placing the dross pan with the hot metal dross therein into a metal dross confinement unit comprising a gastight chamber of a fixed interior volume. In step 504, the cover of the metal dross confinement unit is placed over its corresponding opening to seal the gastight chamber. At this stage, an optional step 506 of pumping the gas out of the gastight chamber may be performed. In an embodiment, the pressure inside the gastight chamber is near −14.5 psi after pumping the gas out of it.

In step 508, the chemical reaction (e.g., oxidation, nitrogenization or carburization) occurs inside the gastight chamber and depletes the limited amount of gas present inside the gastight chamber, thereby stopping once the gas is completely depleted. As discussed earlier, the gastight chamber is shaped and sealed to withstand a pressure differential (or vacuum) created by the depleting of the gas in the fixed interior volume, until the hot dross is cooled and the chemical reaction has stopped.

According to an embodiment, the temperature inside the gastight confinement chamber is monitored to determine when the dross is sufficiently cool. In an embodiment, the temperature has a given value at which the dross is sufficiently cool which is about 450° C.

The pressure inside the confinement chamber may also be monitored. The pressure inside the confinement chamber will tend toward a perfect vacuum. A pressure monitor device (not shown) may also form part of the confinement unit and be used to monitor the pressure inside the confinement chamber.

Alternatively, it is determined that the cooling is complete after a given period which can be monitored using a timer. In an exemplary embodiment, the given period is from 8 to 16 hours. The performance of method 500 tends to reduce the period for cooling the dross as compared to the methods of the prior art discussed earlier.

Once the cooling is completed, a vacuum relief valve is opened (step 510) to allow for equalization of the pressure between the inside and the outside of the metal dross confinement unit. Alternatively, in step 512, residual gases may be flushed from the confinement chamber.

The cover of the metal dross confinement unit is then opened (step 514), the dross pan is removed from the metal dross confinement unit (step 516) and sent for further processing or disposal (step 518).

According to another embodiment, gas inside the gastight chamber can be pumped through a service port, which may include a valve, to accelerate the creation of the vacuum and thereby increase the yield of the method; i.e., the chemical reaction is stopped earlier and hence more metal is recovered.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A metal dross confinement unit for stopping a chemical reaction involving metal dross and a gas in a surrounding environment, the metal dross confinement unit comprising:
a confinement chamber having a fixed volume, the confinement chamber comprising an opening adapted to receive therethrough a dross pan containing the metal dross; and
a cover for closing the opening and sealing the confinement chamber in a gastight fashion to thereby ensure the fixed volume inside the confinement chamber, the chemical reaction occurring inside the confinement chamber depleting a limited amount of gas present inside the confinement chamber, thereby stopping once the gas is completely depleted.

2. The metal dross confinement unit of claim 1, further comprising a support platform within the confinement chamber, the support platform for receiving the dross pan.

3. The metal dross confinement unit of claim 2, wherein the confinement chamber comprises a substantially cylindrical portion having a cylinder axis.

4. The metal dross confinement unit of claim 3, further comprising a support structure on which is laid the substantially cylindrical portion with the cylinder axis in a substantially horizontal direction.

5. The metal dross confinement unit of claim 4, wherein the cover comprises at least one of a dome portion and a hemispherical portion.

6. The metal dross confinement unit of claim 4, wherein one of the cover and the confinement chamber comprises a cavity adapted to receive an edge portion of the other one of the cover and the confinement chamber thereby forming a seal.

7. The metal dross confinement unit of claim 6, further comprising a gasket within the cavity thereby enhancing a sealing capacity of the seal.

8. The metal dross confinement unit of claim 1, further comprising a service port for connecting a pump thereto and pumping gas out of the metal dross confinement unit.

9. The metal dross confinement unit of claim 1, further comprising a vacuum relief valve for, upon opening, allowing equalization of the pressure between the inside and the outside of the metal dross confinement unit.

10. The metal dross confinement unit of claim 1, wherein the confinement chamber is shaped and sealed to withstand a pressure differential created by the depleting of the gas in the fixed volume, until the metal dross is cooled and the chemical reaction has stopped.

11. A method for stopping a chemical reaction involving metal dross and a gas in a surrounding environment, the method comprising:
sealing a dross pan with the metal dross therein into a gastight chamber of a fixed interior volume, the chemical reaction occurring inside the gastight chamber depleting a limited amount of gas present inside the gastight chamber, thereby stopping once the gas is completely depleted.

12. The method of claim 11, further comprising keeping the dross pan in the gastight chamber for at least one of cooling and holding the metal dross in the dross pan for a given period or until a temperature inside the gastight chamber reaches a given value.

13. The method of claim 12, wherein the given period is between 6 and 16 hours.

14. The method of claim 12, wherein the given value is 450° C.

15. The method of claim 12, further comprising opening a vacuum relief valve after the given period or after the temperature inside the gastight chamber reaches the given value.

16. The method of claim 11, further comprising pumping gas out of the gastight chamber.

17. The method of claim 11, wherein the sealing comprises closing a cover of the gastight chamber.

18. The method of claim 11, further comprising placing the dross pan with the metal dross therein in the gastight chamber.

19. Use of a gastight chamber for stopping a chemical reaction involving metal dross and a gas in a surrounding environment.

20. The use of claim 19, where the gastight chamber is a vacuum chamber.
